(19) United States
(12) Patent Application Publication
(10) Pub. No.: US 2026/0288556 A1
(43) Pub. Date: Sep. 24, 2026

(54) MODULE AND METHOD FOR DETECTING ANOMALIES IN A CRITICAL INFRASTRUCTURE SYSTEM

(71) Applicant: Ensign Infosecurity Pte. Ltd., Singapore (SG)

(72) Inventors: Wen Ni Pang, Singapore (SG); Jonathan Whye Wei Goh, Singapore (SG)

(21) Appl. No.: 19/248,674

(22) Filed: Jun. 25, 2025

(30) Foreign Application Priority Data
Mar. 24, 2025 (SG) 10202500760U

(51) Int. Cl. G06F 11/07

(52) U.S. Cl. CPC G06F 11/0751; G06F 11/0721

(57) ABSTRACT

This disclosure describes a module and method for detecting anomalies in a critical infrastructure (CI) system based on pre-generated rule sets and a trained anomaly detection model. The pre-generated rule sets are automatically generated based on state variables associated with the CI system, while the anomaly detection model is trained on features that are automatically extracted from the CI system. Additionally, the module is configured to dynamically regenerate the rule sets and retrain the anomaly detection model in response to a decline in anomaly detection performance to ensure adaptive and continuous optimization of the anomaly detection system.

### CROSS REFERENCE TO RELATED APPLICATION

This application claims the benefit of priority to Singapore patent application no. 10202500760U which was filed on 24 Mar. 2025 the contents of which are hereby incorporated by reference in its entirety for all purposes.

### TECHNICAL FIELD

This application relates to a module and method for detecting anomalies in a critical infrastructure (CI) system based on pre-generated rule sets and a trained anomaly detection model. The pre-generated rule sets are automatically generated based on state variables associated with the CI system, while the anomaly detection model is trained on features that are automatically extracted from the CI system. Additionally, the module is configured to dynamically regenerate the rule sets and retrain the anomaly detection model in response to a decline in anomaly detection performance to ensure adaptive and continuous optimization of the anomaly detection model.

### BACKGROUND

Operational Technology (OT) refers to both hardware and software systems that are used to monitor and control physical devices and processes within an industrial setting and is usually used in critical infrastructure (CI) systems to monitor and control the physical industrial devices and machinery in the CI systems. OT systems are widely used in various critical infrastructure sectors, including industrial control systems (ICS) and supervisory control and data acquisition (SCADA) systems, and are commonly deployed in industries such as oil and gas, electricity generation, and water treatment. Given the essential role of these infrastructures in supporting societal and economic functions, they are high-value targets for cyber threats, with attacks potentially resulting in severe disruptions.

Historically, OT systems operated in isolated environments, disconnected from external networks to reduce their exposure to external security threats. Recently, in order to enhance the data analytics and operational efficiency of OT systems, such systems have increasingly been integrated with IT networks. While such integration has introduced benefits to the OT systems, it has also simultaneously expanded the attack surface for potential cyber intrusions. The risks associated with these integrations are exemplified by past incidents, whereby unauthorized access to industrial control systems have resulted in power outages and attempted alterations of water treatment processes. These incidents demonstrate the need for real-time anomaly detection, as timely identification of irregularities can prevent and mitigate operational risks to such critical infrastructure (CI) systems.

Traditional OT security measures primarily rely on network-based cybersecurity techniques, such as firewalls, Intrusion Detection Systems (IDS), Intrusion Prevention Systems (IPS), and network traffic monitoring. However, these approaches predominantly operate at the network layer, making it challenging to identify and mitigate threats once such IP-layer defenses have been bypassed by malicious third parties. If an adversary gains access to air-gapped networks of Programmable Logic Controllers (PLCs) or SCADA workstations, they could manipulate system operations, causing significant disruptions to industrial processes.

To address these vulnerabilities, those skilled in the art have proposed that anomaly detection be carried out at the sensor level to identify irregular system behavior. One approach proposed by those skilled in the art involves the derivation of operational rules, also known as invariants, from plant design plans and control logic. These operational rules then serve as reference parameters for detecting deviations. Another method proposed by those skilled in the art employs machine learning models, such as multi-layer perceptron (MLP) and decision trees, which utilize invariants as input features to learn normal system behavior. While these models do not require precise mathematical relationships between system components, their effectiveness depends on the “quality” of the invariants that is used to train the models.

Further advancements have leveraged Association Rules Mining (ARM) algorithms to automatically generate operational rules. However, these methods have traditionally required manual intervention to validate the extracted rules against physical system constraints and engineering principles. Additionally, ARM techniques typically require discrete input data, necessitating preprocessing steps to discretize continuous state variables, a task that has historically been performed manually.

A challenge faced by the methods proposed above is their dependence on manual processes, whether for rule derivation from plant design plans and control codes or for the discretization of continuous data. While design-based rule generation has demonstrated effectiveness in anomaly detection, it becomes increasingly labor-intensive and impractical at scale, particularly as the industrial systems grow in complexity. Additionally, the requirement for domain expertise at each stage, from interpreting design plans to ensuring rule accuracy, further complicates large-scale deployment of such methods.

Hence, those skilled in the art are constantly looking for adaptive and scalable anomaly detection solutions that may be automated so that the training and setup of such solutions do not rely on manual interventions while being able to maintain high detection accuracies.

### SUMMARY

In one aspect, the present application discloses an anomaly detection module for detecting anomalies in a critical infrastructure (CI) system whereby the module comprises a processing unit, and a non-transitory media readable by the processing unit. The media stores instructions that when executed by the processing unit causes the processing unit to receive state variables generated by a plurality of components of the CI system, the state variables comprising discrete and continuous state variables. The received continuous state variables are then provided to a discretization module that is configured to discretize the received continuous state variables by assigning each received continuous state variable to a cluster, the cluster being one of a plurality of pre-generated clusters, wherein each of the plurality of pre-generated clusters is associated with a cluster center value. The processing unit then proceeds to combine the discretized continuous state variables and received discrete state variables into discretized state variables before providing the discretized state variables to a rule validation module. It is disclosed that the rule validation module is configured to retrieve rule sets associated with all the plurality of components of the CI system, wherein each rule set was generated by applying pattern mining algorithms to sets of discretized baseline state variables, each set being associated with corresponding components of the CI system; to identify discretized state variables that contravene a rule in the retrieved rule set and flag the component of the CI system associated with the identified discretized state variable with an anomaly tag; and to provide a first list comprising flagged components of the CI system and their corresponding anomaly tags to a priority list database. The processing unit then proceeds to identify anomalous components of the CI system based on the first list stored in the priority list database.

In embodiments of this aspect, the disclosed module further comprising instructions for directing the processing unit to provide the received continuous and discrete state variables to a trained anomaly detection model configured to generate predicted state variables for each of the plurality of continuous components of the CI system based on the received continuous and discrete state variables where for each of the plurality of continuous components of the CI system, the processing unit computes a cumulative sum (CUSUM) value defining a sum of differences between each predicted state variable and its corresponding received state variable over a predefined time window before the processing unit determines whether an anomaly label should be assigned to a continuous component of the CI system by comparing the computed CUSUM value associated with the continuous component to a predetermined anomaly detection threshold. In response to a determination that the CUSUM value associated with the continuous component exceeds the predetermined threshold, the processing unit then associates the corresponding continuous component of the CI system with a corresponding anomaly label. It is disclosed that the processing unit then provides a second list comprising continuous components of the CI system that have been associated with anomaly labels to the priority list database for further evaluation, and the processing unit then identifies anomalous components of the CI system based on the first and second lists stored in the priority list database.

In embodiments of this aspect, the application of pattern mining algorithms to sets of discretized baseline state variables associated with the corresponding components of the CI system to generate each of the rule sets comprises instructions for directing the processing unit to instruct a rules generation module to perform the following steps for each set of discretized baseline state variables associated with the corresponding components of the CI system. The steps comprise the application of a Frequent-Pattern growth (FP-growth) algorithm to the set of discretized baseline state variables, the FP-growth algorithm being configured to identify frequent item-sets within the set of discretized baseline state variables, and the application of an Association Rules Mining (ARM) algorithm to the identified frequent item-sets to derive association rules that characterize normal behaviors of the corresponding components of the CI system.

In embodiments of this aspect, it is disclosed that each of the plurality of pre-generated clusters is generated by the discretization module being configured to receive groups of continuous baseline state variables, wherein each group comprises continuous baseline state variables that are associated with a corresponding component of the CI system, to cluster continuous baseline state variables in each of the groups independently from continuous baseline state variables of other groups, using a K-means clustering algorithm, wherein an optimal number of clusters (k-value) for the K-means clustering algorithm for each of the groups is determined using a Kneedle algorithm, and to classify each of the clusters in each of the groups as pre-generated clusters associated with a corresponding component of the CI system, whereby each of the pre-generated clusters is associated with a cluster center value that defines the centroid of the cluster.

In embodiments of this aspect, it is disclosed that the trained anomaly detection model is trained by receiving groups of continuous and discrete baseline state variables, wherein each group comprises continuous and discrete baseline state variables that are associated with a corresponding continuous component of the CI system, extracting and selecting optimized feature sets for the continuous components of the CI system by applying a Genetic algorithm to the groups of continuous and discrete baseline state variables, and training the anomaly detection model using the selected optimized feature sets, the groups of continuous and discrete baseline state variables and a list of continuous components of the CI system, to generate predicted state variables for a corresponding continuous component at specific timestamps.

In embodiments of this aspect, the disclosed anomaly detection module further comprises instructions for directing the processing unit to continuously monitor the received continuous state variables to detect data drift, changes to the CI system or performance deviations, and to trigger retraining of the trained anomaly detection model or regenerating of the rule sets associated with each of the plurality of components of the CI system in response to a determination that data drift, changes to the CI system or performance deviations were detected.

In another aspect of the disclosure, the present application discloses a method for detecting anomalies in a critical infrastructure (CI) system. The disclosed method comprises the steps of receiving, using an anomaly detection module, state variables generated by a plurality of components of the CI system, the state variables comprising discrete and continuous state variables, and providing the received continuous state variables to a discretization module. The discretization module is then configured to discretize the received continuous state variables by assigning each received continuous state variable to a cluster, the cluster being one of a plurality of pre-generated clusters, wherein each of the plurality of pre-generated clusters is associated with a cluster center value. The method then proceeds to combine, using the anomaly detection module, the discretized continuous state variables and received discrete state variables into discretized state variables and then provides the discretized state variables to a rule validation module. The rule validation module is then configured to retrieve rule sets associated with all the plurality of components of the CI system, wherein each rule set was generated by applying pattern mining algorithms to sets of discretized baseline state variables, each set being associated with corresponding components of the CI system, to identify discretized state variables that contravene a rule in the retrieved rule set and flag the component of the CI system associated with the identified discretized state variable with an anomaly tag, and to provide a first list comprising flagged components of the CI system and their corresponding anomaly tags to a priority list database. The method then proceeds to identify anomalous components of the CI system based on the first list stored in the priority list database.

In embodiments of this another aspect, the method further comprises the steps of providing the received continuous and discrete state variables to a trained anomaly detection model configured to generate predicted state variables for each of the plurality of continuous components of the CI system based on the received continuous and discrete state variables where for each of the plurality of continuous components of the CI system, the method computes a cumulative sum (CUSUM) value defining a sum of differences between each predicted state variable and its corresponding received state variable over a predefined time window before determining whether an anomaly label should be assigned to a continuous component of the CI system by comparing the computed CUSUM value associated with the continuous component to a predetermined anomaly detection threshold. In response to a determination that the CUSUM value associated with the continuous component exceeds the predetermined threshold, the method then associates the corresponding continuous component of the CI system with a corresponding anomaly label before providing a second list comprising continuous components of the CI system that have been associated with anomaly labels to the priority list database for further evaluation. The method then identifies anomalous components of the CI system based on the first and second lists stored in the priority list database.

### BRIEF DESCRIPTION OF THE DRAWINGS

Various embodiments of the present disclosure are described below with reference to the following drawings:

FIG. 1 illustrates a block diagram of components or modules that are provided within an anomaly detection module to perform the steps for detecting anomalies in a critical infrastructure (CI) system in accordance with embodiments of the present disclosure;

FIG. 2 illustrates a block diagram of a processing system for performing embodiments of the present disclosure;

FIG. 3 illustrates a flow diagram depicting the automatic generation of rule sets for the anomaly detection module in accordance with embodiments of the present disclosure;

FIG. 4 illustrates a flow diagram depicting the automatic selection of features for the training of the anomaly detection model in accordance with embodiments of the present disclosure;

FIG. 5A illustrates an example of a population of size 2 for a population size parameter of a Genetic algorithm;

FIG. 5B illustrates an example of a creation of new individuals based on a crossover between parent individuals as part of the steps of the Genetic algorithm illustrated in FIG. 5A;

FIG. 6 illustrates a flow diagram showing an overview of the generation of the rule sets and the training of the anomaly detection model for the anomaly detection module in accordance with embodiments of the present disclosure;

FIG. 7 illustrates a flow diagram depicting the continuous integration and deployment of the anomaly detection module in accordance with embodiments of the present disclosure;

FIG. 8 illustrates a flow chart showing the process for detecting anomalies in a CI system based on pre-generated rule sets using the anomaly detection module in accordance with embodiments of the disclosure; and

FIG. 9 illustrates a flow chart that incorporates the steps of using a trained anomaly detection model into the process illustrated in FIG. 8 to detect the anomalies in the CI system in accordance with embodiments of the disclosure.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

In the context of various embodiments, the term “state variables” means measurable parameters that represent the operational conditions of components within a critical infrastructure (CI) system, including both continuous and discrete parameters.

In the context of various embodiments, the term “critical infrastructure (CI) system” means a network of interconnected physical and computing systems that are essential for the functioning, security, and stability of societal and economic operations. These systems include, but are not limited to, industrial control systems, supervisory control and data acquisition (SCADA) systems, power grids, water treatment facilities, oil and gas pipelines, and transportation networks.

One skilled in the art will recognize that certain functional units in this description have been labelled as modules throughout the specification. The person skilled in the art will also recognize that a module may be implemented as circuits, logic chips or any sort of discrete component. Still further, one skilled in the art will also recognize that a module may be implemented in software which may then be executed by a variety of processor architectures. In embodiments of the disclosure, a module may also comprise computer instructions or executable code that may instruct a computer processor to carry out a sequence of events based on instructions received. The choice of the implementation of the modules is left as a design choice for a person skilled in the art and does not limit the scope of the claimed subject matter in any way.

The disclosed anomaly detection module comprises a unified, automated framework that seamlessly connects data pre-processing, rule generation, feature extraction, model training, and anomaly detection processes together, ensuring that all components operate in a structured sequence. This integration eliminates the need for manual intervention at various stages, thereby enhancing efficiency and scalability in detecting anomalies within CI systems.

In particular, the disclosed anomaly detection module employs an automated rule generation process, which leverages the association rules mining (ARM) algorithm to identify underlying operational rules within the CI system—that is to be monitored. As the ARM algorithm requires discrete input data, continuous state variables from the CI system are discretized using a combination of K-means clustering and the Kneedle algorithm which enables the automatic grouping of continuous values without requiring prior domain knowledge, while the Kneedle algorithm determines the optimal number of clusters dynamically.

Additionally, the module incorporates a Genetic algorithm-based feature selection mechanism to optimize model training. This mechanism extracts optimized sets of features for each continuous component within the CI system and through the automation of this feature selection and extraction process, the module eliminates the reliance on human expertise for feature engineering, making the model training pipeline more efficient. The selected features may then be used to train a long short-term memory (LSTM) autoencoder, which captures temporal dependencies in sequential data. The LSTM component retains historical patterns, while the autoencoder reduces dimensionality and isolates critical features, thereby enhancing the system's ability to differentiate between normal and anomalous patterns.

As the module is fully data-driven and employs machine learning-based models, its performance may be influenced by evolving operational conditions. To address this, a continuous integration/continuous deployment (CI/CD) pipeline is incorporated into the module to enable the system to dynamically regenerate rules, update model features, retrain models, and automatically deploy anomaly detection updates.

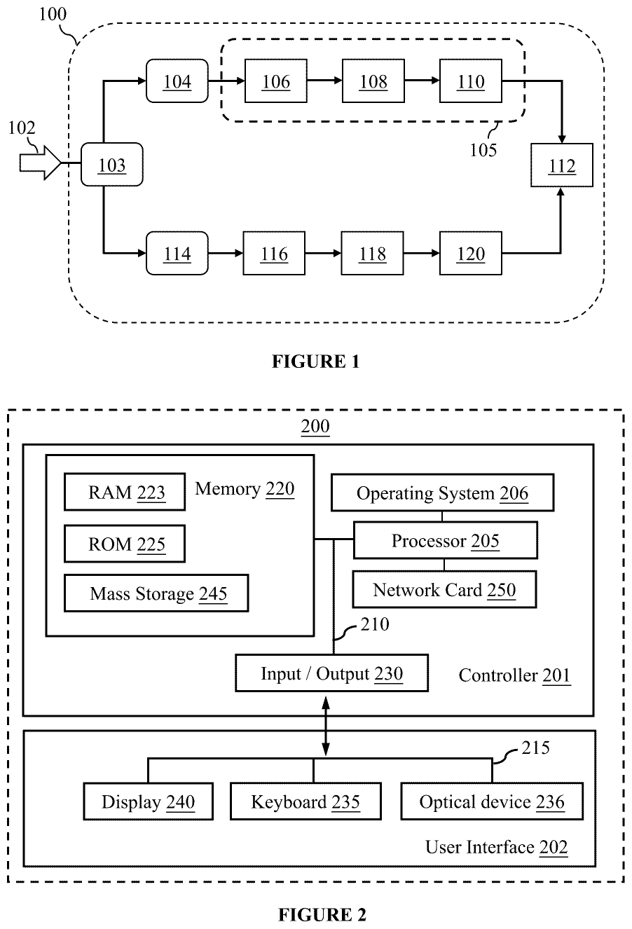

A block diagram of components or modules that are provided within an anomaly detection module to perform the steps for detecting anomalies in a critical infrastructure (CI) system in accordance with embodiments of the present disclosure is illustrated in FIG. 1. Anomaly detection module 100 comprises of several interconnected modules and processes that are configured to work together to detect the occurrence of an anomaly in a CI system. Upon initialization, anomaly detection module 100 establishes a cumulative sum (CUSUM) of differences for each continuous component of the CI system. This is achieved by creating a queue of predefined window size, initially populated with zeros. Additionally, a trigger count is initialized for each component, with its value set to zero at the start. The trigger count is then updated dynamically with every new incoming data point where the purpose of this trigger count is to track the frequency with which a component is involved in rule violations.

Anomaly detection module 100, which is communicatively coupled to a CI system through wired and/or wireless means, then receives state variables 102 as generated by components of a CI system where received state variables 102 may include continuous and/or discrete types of state variables. Received state variables 102 are then provided to pre-processing module 103 for further processing.

Upon receiving state variables 102, pre-processing module 103 then processes state variables 102 with a data cleaning process to ensure that state variables 102 are compatible with subsequent modules and/or processing steps in anomaly detection module 100. During the data cleaning process, state variables 102 will be structured and formatted to align the contents of state variables 102 with anomaly detection module 100's requirements. Datapoints that are missing in state variables 102 are attended by pre-processing module 103 either by removing datapoints with missing values if their proportion is negligible relative to the overall dataset or by filling in missing datapoints using data from previous timestamps to maintain the sequential integrity of time-series data in state variables 102. Furthermore, redundant datapoints, such as those representing inactive backup pumps, will be eliminated by pre-processing module 103 at this stage as such components remain in a constant state throughout operations and typically do not exhibit meaningful interactions with other active components.

Once the data cleaning process has been completed, pre-processing module 103 then proceeds to differentiate and classify discrete and continuous components (i.e., components of the CI system that are associated with discrete or continuous state variables) based on the cardinality of the datapoints in state variables 102, where cardinality refers to a measurement of the uniqueness of values within each state variable over the dataset. In embodiments of the disclosure, it is assumed that continuous components would generate state variables with a wide range of values and as a result exhibit high cardinality, whereas discrete components would be constrained to generate state variables having a finite set of distinct values, and as such would exhibit low cardinality. The differentiation process performed by pre-processing module 103 is based on a threshold-based approach, wherein components that generate state variables with unique value counts below the threshold are categorized as discrete components, while those exceeding the threshold are classified as continuous components. For example, if the threshold was set to five, any component that generates state variables with five or fewer distinct values would be designated as discrete, whereas others are considered continuous. Given that the types of sensors and actuators within a CI system remain largely unchanged over time, it can be seen that this cardinality-based classification is a stable and reliable method. It should be noted that the threshold need only be configured by an operator of the CI system during the system's initial setup and typically does not require frequent adjustments.

Additionally, pre-processing module 103 may identify a specific process to which each component belongs as CI systems are typically organized into distinct operational processes, with each process serving a specialized function and working collectively to achieve system-wide objectives. For example, the state of actuators within each process may be governed by programmable logic controllers (PLCs), which may be configured to execute predefined control codes based on the system's design specifications. Sensors may be employed to capture real-time physical and chemical properties of the system as the actuators adjust operational parameters. During operation, each PLC would receive information regarding the CI system's state from both sensors and adjacent PLCs, enabling the PLC to determine appropriate actuation responses. As a result, it can be said that the CI system operates in a deterministic manner, meaning that identical system states will lead to identical PLC decisions. Since processes within a CI system are typically interconnected in a sequential manner, they are most influenced by adjacent processes.

The association of a component with its corresponding process, i.e., component-to-process mapping, can often be inferred from the component's naming conventions, provided that the naming conventions follow a structured format. For example, in a dataset for a water filtration plant, the first numerical digit following the alphabetic characters in a component's identifier may correspond to its process. Thus, in this example, a component labeled “FIT101” would imply that it is associated with Process 1. While naming conventions may vary across different facilities, once assigned, such naming conventions generally remain consistent over the plant's operational lifespan, requiring only a one-time configuration during deployment of anomaly detection module 100.

Pre-processing module 103 then provides state variables 102, which have been processed and differentiated into continuous and discrete state variables, to discretization module 104. Upon receiving the pre-processed state variables, discretization module 104 proceeds to discretize the continuous state variables contained within the pre-processed state variables by assigning each continuous state variable to a cluster, the cluster being one of a plurality of pre-generated clusters, wherein each of the plurality of pre-generated clusters is associated with a cluster center value. For example, FIT101 may be associated with two clusters, labeled ‘0’ and ‘1’ where each of the cluster centers may represent the central values within each cluster, which in this case correspond to 0 m/s and 2 m/s, respectively. Hence, a state variable of 1.9 m/s would be closer to the cluster center at 2 m/s and as such would therefore be assigned to cluster ‘1’. Once all the continuous state variables have been discretized and replaced with their respective cluster labels, each state variable may be subsequently renamed to include the corresponding component name as a prefix for clarity and consistency in data representation. The detailed discretization steps performed by discretization module 104 will be described in greater detail in the later sections.

The continuous state variables, after undergoing discretization in discretization module 104, are combined with the pre-processed discrete state variables to form a unified set of discretized state variables. These discretized state variables are then provided to rule validation module 105 for further analysis. At step 106, rule validation module 105 retrieves all the rule sets associated with the components of the CI system. These rule sets were previously generated by applying pattern mining algorithms to sets of discretized baseline state variables, where each set of discretized baseline state variables corresponds to a specific component within the CI system.

Following rule retrieval, rule validation module 105 evaluates whether any of the discretized state variables violate a rule within the retrieved rule set. If a violation is detected, the corresponding components of the CI system associated with the contravening state variables are flagged with an anomaly tag at step 108. The rule validation module 105 then compiles a first list of flagged components and their associated anomaly tags, which is subsequently stored in a priority list database at step 110.

In embodiments of the disclosure, step 108 may comprise the following processes. For each retrieved rule, which consists of an antecedent and a consequent, rule validation module 105 first assesses whether the antecedent condition is met. If the antecedent condition is false, the rule is skipped, and the system proceeds to evaluate the next rule using the same discrete state variable, as the rule is only applicable when the antecedent condition holds. If the antecedent is true, the system then verifies whether the consequent condition is also true. If both conditions are true, the rule is satisfied, and the system moves on to the next rule without flagging an anomaly. However, if the consequent condition is false, the system flags all components associated with the rule as anomalous. Additionally, the trigger count for each component in the violated rule is incremented by 1. Rule validation module 105 then repeats the process for the next discrete state variable until all the discretized state variables have been processed. For example, if a rule states MV101_1→P102_0, and the consequent (P102_0) is not met by the discrete state variable that is being processed, then both MV101 and P102 will have their trigger counts increased.

As illustrated in FIG. 1, pre-processing module 103 also provides state variables 102 to trained anomaly detection model 114. In embodiments of the disclosure, trained anomaly detection model 114 may comprise a plurality of trained anomaly detection models whereby each model has been trained using baseline continuous and discrete baseline state variables associated with each of the continuous components of the CI system. The detailed steps for the training of anomaly detection model 114 and/or the training of the plurality of trained anomaly detection models are described in greater detail in the subsequent sections.

In embodiments of the disclosure, as each of the state variables are tagged with unique component identifiers during data acquisition processes at the CI system, trained anomaly detection model 114 is able to identify the continuous component in the CI system to which each of the state variables are associated with. For each identified continuous component in the CI system, trained anomaly detection model 114 then utilizes a trained anomaly detection model associated with the continuous component to generate predicted state variables for the particular component.

These predicted state variables are then used with the actual continuous state variables (as received from pre-processing module 103) to compute a cumulative sum (CUSUM) value defining a sum of differences between each predicted state variable and its corresponding received state variable over a predefined time window, e.g., between 10 and 20 seconds. The CUSUM queue comprising the predefined time window is then updated. This takes place at step 116.

It should be noted that the CUSUM queue operates on a First-In-First-Out (FIFO) principle, meaning that a newly computed difference (between a predicted state variable and the actual continuous state variable) would be added to the back of the queue, while the oldest value would be dequeued and removed. The CUSUM of all values within the queue is then computed, providing a rolling measure of accumulated deviations over a predefined period ensuring that deviations are monitored over time rather than being assessed in isolation.

At step 118, anomaly detection module 100 evaluates whether the CUSUM value exceeds a predefined threshold. If the sum of deviations surpasses this threshold, the corresponding continuous component is flagged as anomalous and may be associated with a corresponding anomaly label. This anomaly label indicates that the component has deviated significantly from expected behavior, suggesting a potential system fault, irregular operation, or external interference. If the CUSUM remains below the threshold, the process continues with new incoming continuous state variables, ensuring continuous monitoring and detection of anomalies in real time. The anomaly detection module 100 then compiles a second list of components that have been associated with anomaly labels and subsequently stores the second list in the priority list database at step 120.

At step 112, anomaly detection module 100 then organizes the first and second lists in the priority list database into separate lists, a list for discrete components and another list for continuous components. This distinction is based on the assumption that the rule-based validation is more effective in identifying anomalies among discrete components, while model-based anomaly detection is more reliable for continuous components. As a result, maintaining separate priority lists allows for more efficient assessment, as the prioritization criteria differ between the two types of components.

In embodiments of the disclosure, in the list for discrete components, the components are arranged according to their trigger counts, ensuring that discrete components that are flagged most frequently are prioritized for inspection. For continuous components, those flagged by the anomaly detection models are assigned higher priority than those that were not, with further ordering being carried out based on trigger counts within their respective groups.

The priority lists greatly assist with the efficient identification and addressing of potential issues. For example, in the event of a cyberattack or system failure, a compromised component may cause cascading anomalies, affecting multiple other components. If too many components are flagged simultaneously, it may become challenging for operators of anomaly detection module 100 to quickly identify the root cause of the issue. The priority list mitigates this challenge by guiding users toward the most critical components for immediate inspection—enabling faster response times.

In other embodiments of the disclosure, anomaly detection module 100 may utilize the information in the priority list database to determine if an anomalous condition has persisted for a predetermined time period, e.g., at least 15 seconds. This may take place at step 112. If the anomaly is found to be transient (lasting less than the predetermined time period), the anomaly detection module 100 continues monitoring the component. However, if the anomaly persists beyond the predetermined time period, the system sorts the flagged components in the priority list based on predefined criteria. Once the updated priority list has been established, an alert is generated, notifying operators of the most critical components that require immediate attention.

An exemplary pseudocode for carrying out the processes in anomaly detection module 100 is set out below as Pseudocode 1.

```
# Initialise CUSUM tracker for each component
set window_size = x # Set window size for CUSUM tracker
for each continuous component:
  initialise CUSUM(component) = [0 * window_size]
for each incoming data point:
  # Initialise variables
  for each component:
    set trigger_count(component) = 0
    if component is continuous:
      set flag(component) = False
  # Check rules
  for each continuous component's value:
    set minimum_difference = infinity
    set closest_cluster = Null
    for each cluster:
      difference = absolute(value − cluster center)
      if difference < minimum_difference:
        minimum_difference = difference
        closest_cluster = cluster
    set value = closest_cluster
  # Rename all values to include component name
  for each component:
    set value = “component_value”
  for each rule:
    if antecedent is true:
      if consequent is true:
        for each component in rule:
          increment trigger_count(component) by 1
  # Check models
  for each continuous component:
    prediction = model prediction value
    difference = absolute(actual − prediction)
    enqueue CUSUM (component) with difference
    dequeue first value from CUSUM (component)
    component_sum = sum(CUSUM(component))
    if component_sum > threshold(component):
      set flag(component) = True
  # Generate priority list
  discrete_priority_list = sort(discrete components based on trigger_count)
  continuous_flagged = [continuous components where flag(component) is True]
  continuous_unflagged = [continuous components where flag(component) is False]
  for group in (continuous_flagged, continuous_unflagged):
    group = sort(components in group based on trigger_count)
  continuous_priority_list = [continuous flagged, continuous unflagged]
```

### Pseudocode 1

In accordance with embodiments of the present disclosure, a block diagram representative of components of processing system 200 that may be provided within anomaly detection module 100, and/or any of the modules shown in FIG. 1 to carry out the computing and processing functions in accordance with embodiments of the disclosure is shown in FIG. 2. One skilled in the art will recognize that the exact configuration of each processing system provided within these modules may be different and the exact configuration of processing system 200 may vary and the arrangement illustrated in FIG. 2 is provided by way of example only.

In embodiments of the disclosure, processing system 200 may comprise controller 201 and user interface 202. User interface 202 is arranged to enable manual interactions between a user and the computing module as required and for this purpose includes the input/output components required for the user to enter instructions to provide updates to each of these modules. A person skilled in the art will recognize that components of user interface 202 may vary from embodiment to embodiment but will typically include one or more of display 240, keyboard 235 and optical device 236.

Controller 201 is in data communication with user interface 202 via bus 215 and includes memory 220, processing unit or processor 205 mounted on a circuit board that processes instructions and data for performing the method of this embodiment, an operating system 206, an input/output (I/O) interface 230 for communicating with user interface 202 and a communications interface, in this embodiment in the form of a network card 250. Network card 250 may, for example, be utilized to send data from these modules via a wired or wireless network to other processing devices or to receive data via the wired or wireless network. Wireless networks that may be utilized by network card 250 include, but are not limited to, Wireless-Fidelity (Wi-Fi), Bluetooth, Near Field Communication (NFC), cellular networks, satellite networks, telecommunication networks, Wide Area Networks (WAN) etc.

Memory 220 and operating system 206 are in data communication with processor 205 via bus 210. The memory components include both volatile and non-volatile memory and more than one of each type of memory, including Random Access Memory (RAM) 223, Read Only Memory (ROM) 225 and a mass storage device 245, the last comprising one or more solid-state drives (SSDs). One skilled in the art will recognize that the memory components described above comprise non-transitory computer-readable media and shall be taken to comprise all computer-readable media except for a transitory, propagating signal. Typically, the instructions are stored as program code in the memory components but can also be hardwired. Memory 220 may include a kernel and/or programming modules such as a software application that may be stored in either volatile or non-volatile memory.

Herein the term “processor” or “processing unit” is used to refer generically to any device or component that can process such instructions and may include: a microprocessor, a processing unit, a microcontroller, a programmable logic device or other computational device. That is, processor 205 may be provided by any suitable logic circuitry for receiving inputs, processing them in accordance with instructions stored in memory and generating outputs (for example to the memory components or on display 240). In this embodiment, processor 205 may be a single core or multi-core processor with memory addressable space. In one example, processor 205 may be multi-core, comprising—for example—an 8 core CPU. In another example, it could be a cluster of CPU cores operating in parallel to accelerate computations.

### Automated Generation of Rule Sets

In embodiments of the disclosure, the generation of rule sets for a CI system begins with the initial acquisition of baseline state variables associated with the components of the CI system where these baseline state variables represent the state variables generated by the components of the CI system during normal operation. These baseline state variables may be collected over a time period comprising a few weeks.

As an example, the baseline state variables used for the generation of the rule sets may be obtained from a scaled-down, high-fidelity industrial testbed designed to emulate a modern CI facility. This testbed consists of multiple sequential processes, each performing a specific function. For example, one process manages the inflow of raw materials or resources, while another process is responsible for the treatment or processing operations. The processes are arranged in a structured sequence, with each step being dependent on the output of the previous one. Within each process, a dedicated set of components is utilized, including actuators such as pumps and motorized valves, and sensors such as flow rate and level sensors. For consistency, actuators and sensors of the same type follow a standardized naming convention, where an identifying prefix denotes the component type, followed by a numerical identifier indicating the process to which it belongs. For example, a flow rate sensor labeled “FIT101” would be associated with a first process in the sequence.

In this example, the actuators within the testbed may operate as discrete components, meaning they assume a finite number of states. For example, the pumps may have two states, such as “Stop” and “Start”, represented by numerical values in the dataset, i.e., ‘1’ and ‘2’ respectively. Motorized valves may operate in multiple states, such as “Transition,” “Closed,” and “Open”, each mapped to a distinct numerical representation, i.e., ‘0’, ‘1’ and ‘2’ respectively. In contrast, sensors provide continuous state variables, capturing real-time measurements such as flow rates, pressure, or temperature, which vary dynamically over time.

The testbed is designed to operate autonomously, with each process being managed by a PLC whereby each PLC receives input from its associated sensors and is able to communicate with other PLCs to coordinate operations across processes. Based on predefined control logic, the PLC may be configured to determine the appropriate adjustments to be made to the actuators to maintain stable and efficient operations. Such architecture closely mirrors large-scale CI facilities, where autonomous control mechanisms and real-time process adjustments are essential for maintaining system stability. The dataset (comprising the state variables) obtained from this testbed includes two distinct types: one recorded under normal operating conditions, i.e., the baseline state variables and another where anomalies were deliberately introduced at periodic intervals.

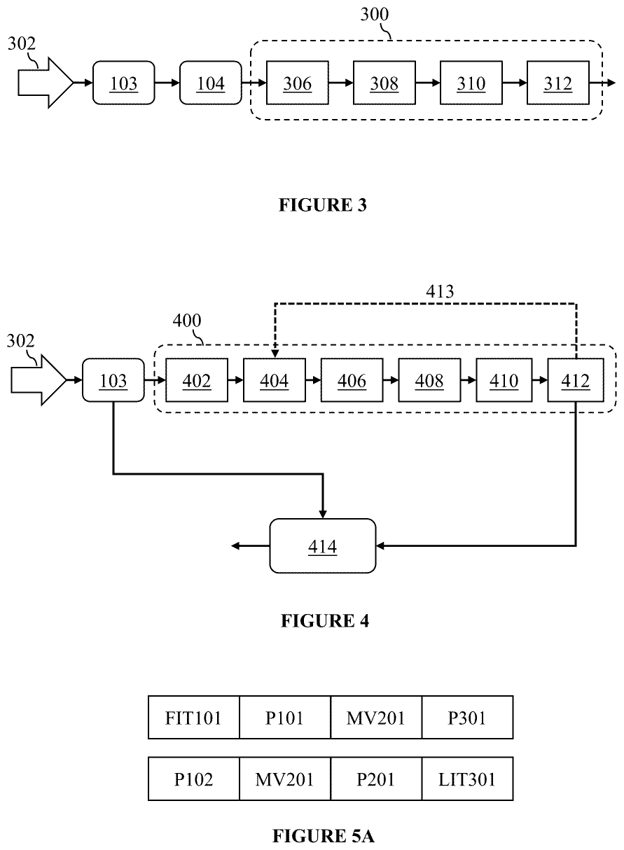

The modules and processes for the automatic generation of rule sets for the anomaly detection module in accordance with embodiments of the present disclosure is illustrated in FIG. 3. It should be noted that the process for the automatic generation of rule sets may be performed within individual processes and across adjacent processes, ensuring that both localized and interdependent behaviours are captured. As illustrated, the process begins with the acquisition of baseline state variables 302 from a CI system. Baseline state variables 302 are then provided to pre-processing module 103, which processes them in accordance with the methods previously described above. The pre-processed baseline state variables are subsequently forwarded to discretization module 104.

In existing methods known to those skilled in the art, discretization is usually performed manually based on an expert's domain expertise, and by relying on a plant's design plans and control codes. For example, flow rate measurements from flow rate meters may be manually categorized into two groups: “flow” and “no flow” where a flow rate of 0 m/s was classified as “no flow,” while any value above 0 m/s was classified as “flow.” This classification was based on an expert's understanding of the flow rate values and their operational significance. Similarly, water level measurements from water level transmitters may be manually divided into four distinct levels—low-low (LL), low (L), high (H), and high-high (HH)—using predefined thresholds derived from plant specifications and control logic. However, this manual discretization process is labor-intensive and time-consuming, making it impractical for scaling from small test environments to large industrial plants.

However, further examination of raw sensor data revealed that, despite being continuous, certain components exhibited value clustering around specific ranges. For example, flow rate measurements from a flow meter often clustered near 2 m/s and 0 m/s, which aligned with the previously defined categories of “flow” and “no flow.” Based on this observation, it was determined that automatic discretization of continuous components may be achieved using K-means clustering by leveraging the natural grouping tendencies of the data. A critical factor in applying K-means clustering is selecting an optimal number of clusters k, as this determines how the continuous values are categorized effectively.

Existing methods for determining the optimal number of clusters k include the Elbow method and the Silhouette score. However, these approaches were found to be unsuitable for use with the disclosed anomaly detection module. In particular, it was found that the Elbow method required manual interpretation of a graphical plot to identify the optimal k value, making it impractical for an automated system while the computation of the Silhouette score required intensive computing resources, making it inefficient for large-scale applications.

In light of the limitations associated with the Elbow method and Silhouette score, discretization module 104 instead employs the Kneedle algorithm to automatically determine the optimal k-value for each continuous component of the CI system. These optimal k-values are then used by the K-means clustering algorithm to discretize the continuous state variables for the respective continuous components as contained within the pre-processed state variables.

To automate the selection of the optimal k-value for each of the continuous components, the Kneedle algorithm is applied to detect the “knee” or “elbow” point in a within-cluster sum of squares (WSS) curve (where the WSS is computed and plotted against the number of clusters k for varying k-values), which signifies the optimal trade-off between clustering compactness and model efficiency. The Kneedle algorithm operates by drawing a straight line connecting the first and last points of the WSS curve, then calculating the perpendicular distance of each WSS point from this line. The point with the greatest perpendicular distance is identified as the optimal k-value, as it represents the most significant inflection point in the curve.

Once the optimal k-values have been obtained for each of the respective continuous components, K-means clustering is then applied to continuous state variables associated with each respective continuous component using each respective continuous component's k-value to categorize continuous state variables into discrete clusters.

In embodiments of the disclosure, the clusters may be labeled from 0 to k−1, with their corresponding cluster centers representing the midpoint values within each cluster. These cluster centers may be used by anomaly detection module 100 to classify new incoming continuous state variables into their respective clusters, i.e., clusters associated with the corresponding continuous component. Discretization module 104 then replaces the original continuous values of the continuous state variables with their corresponding cluster labels, effectively discretizing the continuous state variables.

For example, if a sensor such as FIT101 is found to have two clusters, all continuous state variables associated with this continuous component would be assigned to either cluster ‘0’ or cluster ‘1’. Similarly, if LIT101 is found to have three clusters, all continuous state variables associated with this continuous component would be mapped to cluster ‘0’, cluster ‘1’, or cluster ‘2’.

Returning to FIG. 3, discretization module 104 then proceeds to discretize the continuous base line state variables contained within the pre-processed baseline state variables and the discretization results are then combined with the pre-processed discrete baseline state variables to form a unified set of discretized baseline state variables. These discretized baseline state variables are then provided to rules generation module 300.

At step 306, rules generation module 300 first incorporates component names into each of the baseline state variables to ensure that identical numerical values across different components are not incorrectly interpreted as having the same meaning. This is achieved by appending a component identifier (e.g., MV101) to its corresponding baseline state variable (e.g., 1 or 2) such that each baseline state variable remains distinct and uniquely identifiable. This prevents unintended associations between baselines state variables that share similar numerical values but represent different physical measurements or operational states.

An example of this transformation is shown in Table 1 below, where each component's state variable is explicitly labeled with its name. Instead of recording only numerical values, the dataset stores combined identifiers, such as MV101_0, FIT101_1, and LIT101_2, ensuring that the other modules in rules generation module 300 are able to correctly recognize and analyze component-specific relationships.

TABLE 1

| MV101 | FIT101 | LIT101 | . . . |
|---|---|---|---|
| MV101_0 | FIT101_0 | LIT101_1 | . . . |
| MV101_1 | FIT101_1 | LIT101_2 | . . . |
| MV101_1 | FIT101_1 | LIT101_0 | |

At step 308, rules generation module 300 then applies a frequent-pattern growth (FP-Growth) algorithm to the transformed baselines state variables to identify frequently occurring item-sets. In this context, each of the item-sets refer to combinations of baseline state variables associated with various components representing frequently occurring baseline state variables that may be governed by underlying physical laws or design principles. The FP-Growth algorithm begins by calculating the frequency of each baseline state variable from the received transformed baseline state variables and then constructs an FP-tree which is a hierarchical data structure that organizes baseline state variables based on their frequency and co-occurrence. The algorithm then recursively traverses the tree to extract frequently occurring item-sets, which comprise combinations of baseline state variables that meet a predefined minimum support threshold (i.e., a minimum frequency), a parameter that must be configured based on each CI system's requirements.

Table 2 below illustrates sample frequently occurring item-sets that were derived from Table 1, where each itemset includes a combination of baseline state variables and their respective frequencies.

TABLE 2

| Itemset | | |
|---|---|---|
| number | Itemset | Frequency |
| 1 | MV101_0, FIT101_0 | 0.33 |
| 2 | MV101_1, FIT101_1 | 0.67 |
| 3 | FIT101_1, LIT101_2 | 0.33 |
| . . . | . . . | . . . |

For example, MV101_0 and FIT101_0 appear together in 33% of cases, while MV101_1 and FIT101_1 co-occur in 67% of cases. If the minimum support parameter were set at 0.5, only itemset number 2 (MV101_1, FIT101_1) would be retained, as it meets the frequency threshold.

In embodiments of the disclosure, the minimum support parameter may be defined as follows:

$$minimum support parameter = \frac{1}{total number of rows in dataset} \qquad equation ( 1 )$$

By defining the minimum support parameter based on equation (1), the system ensures that any itemset occurring at least once within the entire dataset is included in the frequent item-sets output, provided it meets the minimum support threshold. As a result, items that appear at least once will not be filtered out. This approach was chosen to preserve infrequent but normal behavior, ensuring a more comprehensive representation of the baseline state variables. Additionally, the maximum length parameter, which limits the number of items in each itemset, is set to 3 by default. However, these parameters remain fully configurable, allowing users to adjust them as needed to optimize system performance. For example, increasing the minimum support threshold would reduce the number of frequent item-sets and extracted rules, minimizing the time required for manual rule review and validation.

In embodiments of this disclosure, the baseline state variables are processed using two different grouping approaches: individual processes and cross processes. Individual processes refer to isolated system segments, such as process 1, process 2, and so forth. In contrast, cross processes involve analyzing adjacent process groups, such as processes 1 and 2, processes 2 and 3, and so on. This dual approach allows the system to identify both localized and interdependent behavioral patterns.

At step 310, rules generation module 300 then uses an association rule mining (ARM) algorithm to extract association rules from the received item-sets. The rules extracted using the ARM algorithm follow the format of X→Y, where X represents the antecedent and Y represents the consequent. This rule structure can be interpreted as “If X, then Y”.

For example, consider itemset 3 from Table 2, which consists of {FIT101_1, LIT101_2}. From this itemset, the ARM algorithm can generate two possible rules: FIT101_1→LIT101_2 and LIT101_2→FIT101_1.

To refine the rules, the ARM algorithm then evaluates each rule based on a parameter called confidence, which measures the probability that the consequent ‘Y’ is true given that the antecedent ‘X’ is true.

For example, in Rule 1: FIT101_1→LIT101_2, the dataset contains two instances where FIT101_1 is true, but only one of those instances also has LIT101_2 as true, resulting in a confidence value of 0.5. Conversely, in Rule 2: LIT101_2→FIT101_1, there is only one instance where LIT101_2 is true, and in that instance, FIT101_1 is also true, yielding a confidence value of 1. This confidence metric is calculated for all possible rules derived from the frequently occurring item-sets.

To ensure the reliability of the generated rules, the minimum confidence threshold is set at 1, meaning that only rules that always hold true are retained. This decision is based on the fact that the module operates deterministically, governed by plant design specifications and control logic. As a result, rules with confidence values less than 1 are discarded, as they indicate scenarios where the relationship does not consistently hold. In this case, Rule 1 (FIT101_1→LIT101_2) is filtered out because its confidence value is below the threshold, while Rule 2 (LIT101_2→FIT101_1) is retained, as it meets the strict confidence requirement.

After the rule sets have been generated, rules generation module 300 removes duplicates and redundant rules to streamline the rule set. This takes place at step 312. In embodiments of the disclosure, duplicate rules are defined as rules that are exactly identical, meaning they share the same antecedent and consequent. These duplicates are generated because the same components may appear in both individual process datasets and cross-process datasets. For example, rules generated from cross-processes 1 and 2 will naturally include rules already present in the individual datasets for process 1 and process 2. Since these rules are identical, they are removed.

In addition to the removal of duplicate rules, redundant rules—which are not identical but yield the same results when determining anomalies—are also filtered out. For example, assume that Rule 3: MV101_1→LIT101_1, FIT101_0; Rule 4: MV101_1→LIT101_1; and Rule 5: MV101_1→FIT101_0. If MV101 is in state 1 and LIT101 is not in state 1, then both Rule 3 and Rule 4 would be triggered. Similarly, if FIT101 is not in state 0, then both Rule 3 and Rule 5 would be triggered. This indicates that Rule 3 is functionally equivalent to the combination of Rules 4 and 5. To improve interpretability, Rule 3 is discarded, while Rules 4 and 5 are retained. Although keeping Rule 3 would reduce the total number of rules, it does not provide any additional insights into which components are anomalous. Retaining Rules 4 and 5 instead allows for a more granular identification of anomalous components.

To further refine the rule set, the rules are grouped and sorted based on their antecedents and arranged by rule length, which refers to the number of components involved. During a sequential iteration, any rule whose consequent contains component states that are already covered by shorter rules is removed. The inverse process is also performed, where rules are grouped by their consequents, and redundancies in the antecedents are similarly eliminated. After this refinement, rules generation module 300 outputs the final optimized set of rules to be used by anomaly detection module 100.

### Training of Anomaly Detection Model

A flow diagram depicting the automatic selection of features for the training of the anomaly detection model using in anomaly detection module 100 in accordance with embodiments of the present disclosure is illustrated in FIG. 4. As illustrated, the process begins with the acquisition of baseline state variables 302 from a CI system. Baseline state variables 302 are then provided to pre-processing module 103, which processes them in accordance with the methods previously described above. The pre-processed baseline state variables comprising continuous and discrete baseline state variables are subsequently forwarded to genetic algorithm module 400. Genetic algorithm module 400 is configured to generate feature sets for modeling each continuous component individually. In embodiments of the disclosure, feature sets may refer to combinations of continuous and discrete state variables that will be used in the training of the anomaly detection model used in anomaly detection module 100.

To achieve this, a genetic algorithm (GA) is employed by genetic algorithm module 400 as an optimization technique inspired by natural selection. In summary, a random population of an initial population of candidate feature sets is initially generated. The fitness of each candidate feature set is evaluated using a predefined fitness function, which measures how well the selected feature set contributes to model accuracy. Through multiple iterations (generations), the algorithm selects the best-performing feature sets, applies crossover and mutation operations to create new candidates, and replaces weaker feature sets with stronger ones. This evolutionary process continues until the final generation, where the feature set with the highest fitness score is selected as the optimal solution for training the anomaly detection model.

As illustrated in FIG. 4, the initial population of feature sets would be generated based on the pre-processed baseline state variables at step 402. In embodiments of the disclosure, the components of the CI system may also be directly provided to genetic algorithm module 400 during an initial setup phase.

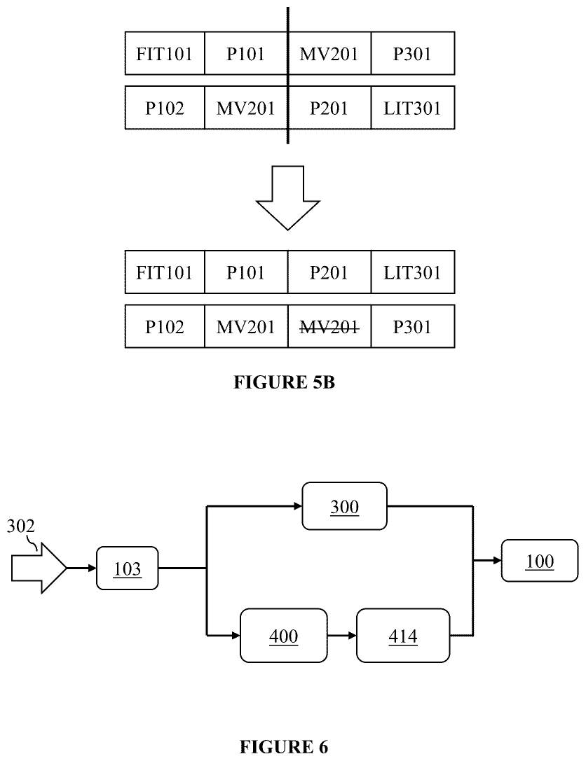

In embodiments of the disclosure, each individual in the Genetic algorithm population represents a feature set comprising of continuous and discrete state variables associated with various continuous components of the CI system, which can be restricted to components from adjacent processes, or from all processes throughout the CI system, depending on the user configuration. Given that CI systems are typically structured into distinct operational processes, with each process serving a specialized function, components within the same process or within adjacent processes have a greater influence on each other. Since the CI system operates deterministically, identical system states lead to identical PLC decisions. As a result, adjacent processes are more directly interconnected, and their components exert a stronger mutual influence compared to components from non-adjacent processes. This interaction is particularly relevant when feature sets are constructed for model training, as including highly interdependent components improves predictive accuracy. The number of individuals generated in the population may then be determined by the population size parameter. For example, if the population size parameter is set to 2, two unique feature sets might be generated, as shown in FIG. 5A, where one feature set consists of {FIT101, P101, MV201, P301}, and another consists of {P102, MV201, P201, LIT301}.

At step 404, a fitness function is employed to evaluate the suitability of each individual feature set for modeling the target component. In embodiments of the disclosure, linear regression may be selected as the fitness function, where the components within the individual feature set are used to train a linear regression model for predicting the state variables of the target component. The fitness score is then determined using the coefficient of determination R², which is calculated using the following formula:

$${R}^{2} = 1 - \frac{R S S}{TSS} \qquad equation ( 2 )$$

where RSS is defined as the residual sum of squares and TSS is defined as the total sum of squares. The R² score measures how much more accurately the model predicts each value compared to simply using the average value of the dataset. A score closer to 1 indicates a stronger predictive performance, meaning the selected feature set is well-suited for modeling the target component.

It should be noted that although linear regression was chosen as the fitness function in the disclosure above, one skilled in the art will recognize that alternative regression methods, such as polynomial regression, can also be employed without departing from this disclosure.

Once the fitness scores have been calculated for all individuals in the population, the top x percentage of individuals, referred to as elites, are then selected to progress to the next generation. This takes place at step 406 and this value x is also referred to as the “elitism rate”. To achieve this, a subset of individuals is selected as “parents” to generate new child individuals. This selection process follows a weighted random selection mechanism, with the weights for each individual being calculated using the following equation:

$${weight}_{x} = \frac{fitness {score}_{x}}{{\sum }_{i = 1}^{N} fitness {score}_{i}} \qquad equation ( 3 )$$

where fitness score; refers to the fitness score of the i^{th} individual in the population, and Nis the population size. After the parent individuals have been selected, each pair would then create two new child solutions.

At step 408, new individuals known as child individuals are produced by undergoing a crossover between the parent individuals. A point of crossover is randomly chosen from the shorter of the two parent individuals. The components after the point of crossover will be swapped between the parent individuals, creating two new child individuals. Any repeats of components would then be removed. FIG. 5B illustrates the crossover between the individuals from the example population shown in FIG. 5A. The crossover process ensures that the child individual contains some components from both parent individuals, creating diversity in the process.

At step 410, the new individuals then undergo a mutation process. The type of mutation is randomly chosen from 3 types-adding, removing and changing. Adding means a new component that is not found in the individual would be randomly added to it, while removing means that one of the components from individual would be removed. Changing means that one of the components in the individual would be changed to a new component, randomly selected from the pool of candidate components with the mutation process introducing variation to widen the search scope for the best solution. At step 412, the generation of individuals and their mutations will continue until the new population is established. With the new population established, the next generation then begins.

At step 413, the calculation of the fitness scores and creation of a new population is repeated until the predefined number of generations has completed. This module allows for the improvement of fitness scores over each generation. Once completed, genetic algorithm module 400 then outputs the final feature sets for each of the continuous components and passes this onto anomaly model training module 414.

At this stage, anomaly model training module 414 receives pre-processed baseline state variables together with a list of continuous components of the CI system, along with the feature sets generated by genetic algorithm module 400. To model the CI system effectively, the anomaly model training module 414 employs a Long Short-Term Memory (LSTM) autoencoder, which integrates both LSTM networks and Autoencoders to serve as the anomaly detection model.

The LSTM autoencoder enables the model to retain and utilize historical information, an ability that is required for accurately modeling CI system dynamics. Since control codes in CI systems dictate component behavior based on the system's prior states, incorporating an LSTM autoencoder allows the model to capture temporal dependencies within the sequence of the CI system's state variables, thereby enhancing predictive accuracy. This ability to recognize sequential patterns enables the system to identify deviations from normal operations, improving the detection of anomalies within the CI system.

Additionally, as the LSTM may be embedded within an autoencoder framework, this facilitates dimensionality reduction to isolate and retain essential features while filtering out irrelevant variations. This enhances the model's capability to detect deviations from normal behavior, making it more effective in identifying anomalies within sequential, time-series data. The detailed workings and training of the LSTM autoencoder based on the pre-processed baseline state variables together with a list of continuous components of the CI system, along with the feature sets are omitted for brevity as such techniques are well understood by one skilled in the art. The trained anomaly detection model is then provided to anomaly detection module 100.

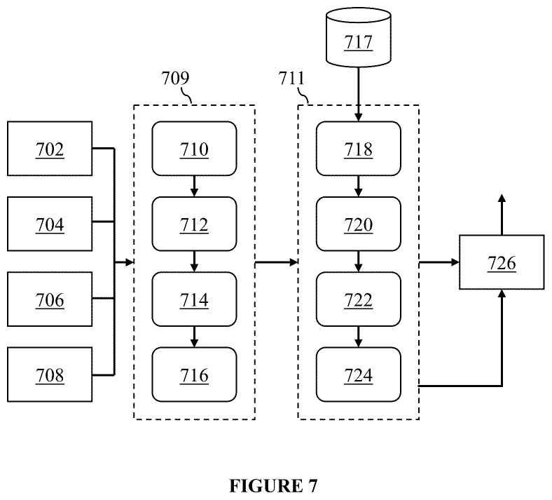

FIG. 6 illustrates an overview of the generation of the rule sets for anomaly detection module 100, and the training of the anomaly detection model, where the trained anomaly detection model 114 is provided to anomaly detection module 100. As illustrated in FIG. 6, it can be seen that baseline state variables 302 are pre-processed by pre-processing module 103 before the pre-processed baseline state variables are subsequently utilized by rules generation module 300, genetic algorithm module 400 and anomaly model training module 414.

In embodiments of the disclosure, anomaly detection module 100 may be provided with a continuous integration and continuous deployment (CI/CD) pipeline specifically tailored for model training, rule regeneration, validation, and deployment, ensuring sustained performance in real-time operational environments. This pipeline is dynamically triggered by factors such as data changes, environmental variations, or performance shifts, allowing for automated retraining, rule regeneration, and seamless deployment of machine learning models. Once initiated, the pipeline executes an end-to-end workflow, beginning with data ingestion and preprocessing, where datasets are version-controlled and systematically tracked. The processed data then moves through automated training phases, leveraging predefined architectures and hyperparameters stored within the system. These phases include rule generation using FP-Growth and ARM algorithms, as well as feature selection and model training to adapt to evolving operational conditions.

FIG. 7 illustrates the various scenarios that may trigger processes in such a CI/CD pipeline. In embodiments of the disclosure, the CI/CD pipeline can be triggered when the following scenarios occur:

Data Drift Detection 702—The pipeline is activated when data drift (i.e., changes in sensor data patterns over time) is detected. This ensures that the anomaly detection models remain accurate and reflective of current system conditions by triggering retraining whenever significant deviations occur.

Training Hyperparameter Updates 704—Adjustments to training hyperparameters (such as learning rate, batch size, or optimization algorithms) initiate the CI/CD pipeline to retrain the anomaly detection model with updated configurations, ensuring optimal performance.

Code Changes 706—Any modifications to the anomaly detection model's code or underlying system architecture automatically triggers the pipeline. This process includes automated testing and validation before training or deployment, ensuring system integrity and stability.

Manual Training 708—Users may manually trigger the training process, particularly after major system modifications or new insights. The CI/CD pipeline ensures that updated anomaly detection models are properly trained, validated, and seamlessly deployed into production.

Either one of the scenarios 702, 704, 706, 708 may trigger the two stages, 709 and 711 of the CI/CD pipeline. In particular, the CI/CD pipeline begins with first stage 709 where a Docker image is built. The Docker image is employed to encapsulate the entire runtime environment, including dependencies, libraries, and configurations, ensuring consistency and reproducibility across different environments. By containerizing the anomaly detection module and its requirements, the Docker image enables seamless deployment, minimizes compatibility issues, and facilitates scalability in production. This approach ensures that the image of the anomaly detection module runs in a self-contained, portable environment, reducing conflicts that may arise when deployed across different infrastructures. In embodiments of the disclosure, first stage 709 of the CI/CD process consists of the following steps:

Clone Code Repository 710—The latest version of the codebase is retrieved from the repository and cloned into the build environment. This ensures that the pipeline always works with the most recent updates, bug fixes, and feature enhancements.

Unit Testing 712—Individual code components and functions are tested in isolation to verify that they operate as expected. Automated tests are run to catch errors early, ensuring that data processing functions, model computations, and transformations behave correctly against predefined inputs and outputs. Successful unit testing confirms the stability of the codebase before proceeding further.

Build Docker Image 714—The application code, dependencies, and configurations are packaged into a Docker container image. This ensures a consistent, self-contained environment, allowing the model and its dependencies to function reliably across different environments. By using the Docker image, the pipeline guarantees portability, reduces compatibility issues, and simplifies deployment and scaling.

Upload to Docker Registry 716—Once the Docker image is built, it is pushed to a centralized Docker registry, making it accessible to other environments, teams, or systems that require deployment or testing. The registry supports version control and tagging, enabling efficient tracking of different versions, rollbacks, and updates if necessary. This allows the CI/CD pipeline to deploy images seamlessly across multiple servers or environments.

Once the Docker image is built and uploaded, second stage 711 of the CI/CD pipeline is triggered which involves the training of the machine learning model and the generating of rule sets. For the training of the anomaly detection model, the pipeline retrieves features generated by the Genetic Algorithm module, preprocesses the data, trains the model, and uploads the trained model to a centralized repository. For the generation of rule sets, the pre-processed data is passed into the FP-Growth and ARM algorithm module, which generates a new set of rules and saves them in the repository. After the model and rules have been validated, they are deployed into the system at step 726, making them available for real-time anomaly detection by anomaly detection module 100.

Beyond deployment, the CI/CD pipeline includes mechanisms for continuous model monitoring in production. It detects data drift or performance degradation, and if deviations exceed predefined thresholds, the pipeline automatically triggers model retraining and redeployment. This ensures that the system maintains optimal performance in response to changing operational conditions. By enabling an automated cycle of training, validation, and deployment, the system remains adaptive, reliable, and capable of long-term anomaly detection, ensuring the continued efficiency of the critical infrastructure monitoring process.

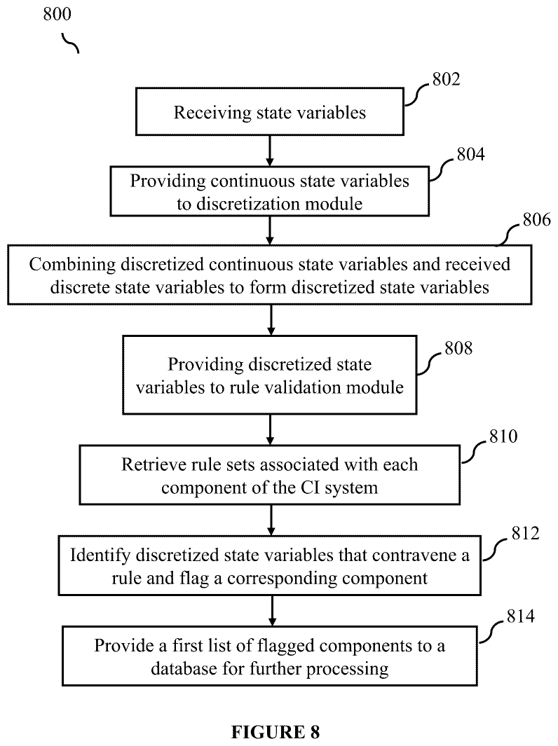

A flowchart which sets out the process for detecting anomalies in a CI system using an anomaly detection module in accordance with embodiments of the present disclosure is illustrated in FIG. 8. In embodiments of the disclosure, process 800 as illustrated in FIG. 8 may be performed by anomaly detection module 100 or any combination of modules described in the sections above.

Process 800 begins at step 802 with process 800 receiving state variables generated by a plurality of components of the CI system where the state variables may comprise discrete and/or continuous state variables. At step 804, process 800 then provides the received continuous state variables to a discretization module. Upon receiving the continuous state variables, the discretization module then proceeds to discretize the received continuous state variables by assigning each received continuous state variable to a cluster, the cluster being one of a plurality of pre-generated clusters, wherein each of the plurality of pre-generated clusters is associated with a cluster center value.

At step 806, process 800 then combines the discretized continuous state variables and received discrete state variables into discretized state variables. Process 800 then subsequently provides the discretized state variables to a rule validation module at step 808.

Upon receiving the discretized state variables, the rule validation module then retrieves rule sets associated with all the plurality of components of the CI system, wherein each rule set was generated by applying pattern mining algorithms to sets of discretized baseline state variables, with each set being associated with corresponding components of the CI system. This takes place at step 810. At step 812, the discretized state variables that contravene a rule in the retrieved rule set are identified and the component of the CI system associated with the identified discretized state variable is flagged with an anomaly tag by the rule validation module. The rule validation module then provides a first list comprising flagged components of the CI system and their corresponding anomaly tags to a priority list database at step 814. Process 800 then proceeds to identify anomalous components of the CI system based on the first list stored in the priority list database.

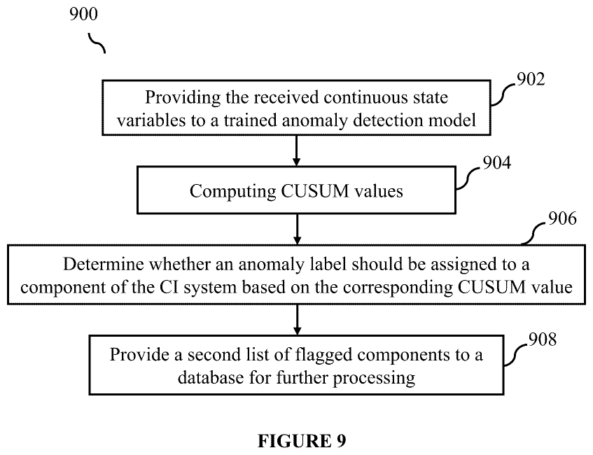

A flowchart which sets out the process for detecting anomalies in a CI system using a trained anomaly detection model that is provided with the anomaly detection module in accordance with embodiments of the present disclosure is illustrated in FIG. 9. In embodiments of the disclosure, process 900 as illustrated in FIG. 9 may be performed by anomaly detection module 100 or any combination of modules described in the sections above.

Process 900 begins at step 902 by providing the received continuous and discrete state variables to a trained anomaly detection model. The trained anomaly detection model may then generate predicted state variables for each of the plurality of continuous components of the CI system based on the received continuous and discrete state variables. For each of the plurality of continuous components of the CI system, process 900 may then compute a cumulative sum (CUSUM) value defining a sum of differences between each predicted state variable and its corresponding received state variable over a predefined time window. This takes place at step 904. At step 906, process 900 then determines whether an anomaly label should be assigned to a continuous component of the CI system by comparing the computed CUSUM value associated with the continuous component to a predetermined anomaly detection threshold, whereby in response to a determination that the CUSUM value associated with the continuous component exceeds the predetermined threshold, process 900 associates the corresponding continuous component of the CI system with a corresponding anomaly label. Process 900 then provides, at step 908, a second list comprising continuous components of the CI system that have been associated with anomaly labels to the priority list database for further evaluation. Process 900 then identifies anomalous components of the CI system based on the first and second lists stored in the priority list database.

In embodiments of the disclosure, the step of applying pattern mining algorithms to sets of discretized baseline state variables associated with the corresponding components of the CI system to generate each of the rule sets comprises the steps of process 800 instructing a rules generation module to for each set of discretized baseline state variables associated with the corresponding components of the CI system, apply a Frequent-Pattern growth (FP-growth) algorithm to the set of discretized baseline state variables, the FP-growth algorithm being configured to identify frequent item-sets within the set of discretized baseline state variables, and apply an Association Rules Mining (ARM) algorithm to the identified frequent item-sets to derive association rules that characterize normal behaviors of the corresponding components of the CI system.

In embodiments of the disclosure, each of the plurality of pre-generated clusters is generated by the discretization module being configured to receive groups of continuous baseline state variables, wherein each group comprises continuous baseline state variables that are associated with a corresponding component of the CI system; cluster continuous baseline state variables in each of the groups independently from continuous baseline state variables of other groups, using a K-means clustering algorithm, wherein an optimal number of clusters (k-value) for the K-means clustering algorithm for each of the groups is determined using a Kneedle algorithm; and classify each of the clusters in each of the groups as pre-generated clusters associated with a corresponding component of the CI system, whereby each of the pre-generated clusters is associated with a cluster center value that defines the centroid of the cluster.

In embodiments of the disclosure, the trained anomaly detection model is trained by receiving groups of continuous and discrete baseline state variables, wherein each group comprises continuous and discrete baseline state variables that are associated with a corresponding continuous component of the CI system; extracting and selecting optimized feature sets for the continuous components of the CI system by applying a Genetic algorithm to the groups of continuous and discrete baseline state variables; and training the anomaly detection model using the selected optimized feature sets, the groups of continuous and discrete baseline state variables and a list of continuous components of the CI system, to generate predicted state variables for a corresponding continuous component at specific timestamps.

In embodiments of the disclosure, a fitness function of the Genetic algorithm may comprise a linear regression model and/or the anomaly detection model may comprise a Long Short-Term Memory (LSTM) autoencoder model.

In embodiments of the disclosure, process 800 may further continuously monitor the received continuous state variables to detect data drift, changes to the CI system or performance deviations, and trigger retraining of the trained anomaly detection model or regenerating of the rule sets associated with each of the plurality of components of the CI system in response to a determination that data drift, changes to the CI system or performance deviations were detected.

In embodiments of the disclosure, the triggering of the regenerating of the rule sets by process 800 may further comprise process 800 building a docker image of the anomaly detection module, and instructing the rule validation module to regenerate the rule sets within the docker image by: obtaining updated sets of discretized baseline state variables, each updated set being associated with a corresponding component of the CI system, wherein for each updated set of discretized baseline state variables, applying a Frequent-Pattern growth (FP-growth) algorithm to the updated set of discretized baseline state variables, the FP-growth algorithm being configured to identify frequent item-sets within the updated set of discretized baseline state variables, and applying an Association Rules Mining (ARM) algorithm to the identified frequent item-sets to derive association rules that characterize normal behaviors of the corresponding components of the CI system.

In embodiments of the disclosure, the triggering of the retraining of the trained anomaly detection model by process 800 may further comprise process 800 building a docker image of the anomaly detection module, and retraining the anomaly detection model within the docker image by performing the steps of: receiving updated groups of continuous and discrete baseline state variables, wherein each updated group comprises updated continuous and discrete baseline state variables that are associated with a corresponding continuous component of the CI system; extracting and selecting optimized feature sets for the continuous components of the CI system by applying a Genetic algorithm to the updated groups of continuous and discrete baseline state variables; and training the anomaly detection model using the selected optimized feature sets, the updated groups of continuous and discrete baseline state variables and a list of continuous components of the CI system, to generate predicted state variables for a corresponding continuous component at specific timestamps.

Numerous other changes, substitutions, variations, and modifications may be ascertained by the skilled in the art and it is intended that the present application encompass all such changes, substitutions, variations, and modifications as falling within the scope of the appended claims.

1. An anomaly detection module for detecting anomalies in a critical infrastructure (CI) system, the system comprising:
a processing unit; and
a non-transitory media readable by the processing unit, the media storing instructions that when executed by the processing unit causes the processing unit to:
receive state variables generated by a plurality of components of the CI system, the state variables comprising discrete and continuous state variables;
provide the received continuous state variables to a discretization module configured to:
discretize the received continuous state variables by assigning each received continuous state variable to a cluster, the cluster being one of a plurality of pre-generated clusters, wherein each of the plurality of pre-generated clusters is associated with a cluster center value;
combine the discretized continuous state variables and received discrete state variables into discretized state variables and provide the discretized state variables to a rule validation module configured to:
retrieve rule sets associated with all the plurality of components of the CI system, wherein each rule set was generated by applying pattern mining algorithms to sets of discretized baseline state variables, each set being associated with corresponding components of the CI system,
identify discretized state variables that contravene a rule in the retrieved rule set and flag the component of the CI system associated with the identified discretized state variable with an anomaly tag,
provide a first list comprising flagged components of the CI system and their corresponding anomaly tags to a priority list database; and
identify anomalous components of the CI system based on the first list stored in the priority list database.

2. The anomaly detection module according to claim 1 further comprising instructions for directing the processing unit to:
provide the received continuous and discrete state variables to a trained anomaly detection model configured to generate predicted state variables for each of the plurality of continuous components of the CI system based on the received continuous and discrete state variables;
for each of the plurality of continuous components of the CI system, compute a cumulative sum (CUSUM) value defining a sum of differences between each predicted state variable and its corresponding received state variable over a predefined time window;
determine whether an anomaly label should be assigned to a continuous component of the CI system by comparing the computed CUSUM value associated with the continuous component to a predetermined anomaly detection threshold, whereby in response to a determination that the CUSUM value associated with the continuous component exceeds the predetermined threshold, associate the corresponding continuous component of the CI system with a corresponding anomaly label;
provide a second list comprising continuous components of the CI system that have been associated with anomaly labels to the priority list database for further evaluation; and
identify anomalous components of the CI system based on the first and second lists stored in the priority list database.

3. The anomaly detection module according to claim 1, wherein the applying of pattern mining algorithms to sets of discretized baseline state variables associated with the corresponding components of the CI system to generate each of the rule sets comprises instructions for directing the processing unit to:
instruct a rules generation module to:
for each set of discretized baseline state variables associated with the corresponding components of the CI system,
apply a Frequent-Pattern growth (FP-growth) algorithm to the set of discretized baseline state variables, the FP-growth algorithm being configured to identify frequent item-sets within the set of discretized baseline state variables, and
apply an Association Rules Mining (ARM) algorithm to the identified frequent item-sets to derive association rules that characterize normal behaviours of the corresponding components of the CI system.

4. The anomaly detection module according to claim 1, wherein each of the plurality of pre-generated clusters is generated by the discretization module being configured to:
receive groups of continuous baseline state variables, wherein each group comprises continuous baseline state variables that are associated with a corresponding component of the CI system;
cluster continuous baseline state variables in each of the groups independently from continuous baseline state variables of other groups, using a K-means clustering algorithm, wherein an optimal number of clusters (k-value) for the K-means clustering algorithm for each of the groups is determined using a Kneedle algorithm; and
classify each of the clusters in each of the groups as pre-generated clusters associated with a corresponding component of the CI system, whereby each of the pre-generated clusters is associated with a cluster center value that defines the centroid of the cluster.

5. The anomaly detection module according to claim 1, wherein the trained anomaly detection model is trained by:
receiving groups of continuous and discrete baseline state variables, wherein each group comprises continuous and discrete baseline state variables that are associated with a corresponding continuous component of the CI system;
extracting and selecting optimized feature sets for the continuous components of the CI system by applying a Genetic algorithm to the groups of continuous and discrete baseline state variables; and
training the anomaly detection model using the selected optimized feature sets, the groups of continuous and discrete baseline state variables and a list of continuous components of the CI system, to generate predicted state variables for a corresponding continuous component at specific timestamps.

6. The anomaly detecting module according to claim 5, wherein a fitness function of the Genetic algorithm comprises a linear regression model.

7. The anomaly detection module according to claim 5, wherein the anomaly detection model comprises a Long Short-Term Memory (LSTM) autoencoder model.

8. The anomaly detection module according to claim 1 further comprising instructions for directing the processing unit to:
continuously monitor the received continuous state variables to detect data drift, changes to the CI system or performance deviations; and
trigger retraining of the trained anomaly detection model or regenerating of the rule sets associated with each of the plurality of components of the CI system in response to a determination that data drift, changes to the CI system or performance deviations were detected.

9. The anomaly detection module according to claim 8 wherein instructions for triggering the regenerating of the rule sets further comprises instructions for directing the processing unit to:
build a docker image of the anomaly detection module; and
instruct the rule validation module to regenerate the rule sets within the docker image by:
obtaining updated sets of discretized baseline state variables, each updated set being associated with a corresponding component of the CI system, wherein for each updated set of discretized baseline state variables,
applying a Frequent-Pattern growth (FP-growth) algorithm to the updated set of discretized baseline state variables, the FP-growth algorithm being configured to identify frequent item-sets within the updated set of discretized baseline state variables, and
applying an Association Rules Mining (ARM) algorithm to the identified frequent item-sets to derive association rules that characterize normal behaviours of the corresponding components of the CI system.

10. The anomaly detection module according to claim 8 wherein instructions for triggering the retraining of the trained anomaly detection model further comprises instructions for directing the processing unit to:
build a docker image of the anomaly detection module; and
retrain the anomaly detection model within the docker image by performing the steps of:
receiving updated groups of continuous and discrete baseline state variables, wherein each updated group comprises updated continuous and discrete baseline state variables that are associated with a corresponding continuous component of the CI system;
extracting and selecting optimized feature sets for the components of the CI system by applying a Genetic algorithm to the updated groups of continuous and discrete baseline state variables; and
training the anomaly detection model using the selected optimized feature sets, the updated groups of continuous and discrete baseline state variables and a list of continuous components of the CI system, to generate predicted state variables for a corresponding component at specific timestamps.

11. A method for detecting anomalies in a critical infrastructure (CI) system, the method comprising:
receiving, using an anomaly detection module, state variables generated by a plurality of components of the CI system, the state variables comprising discrete and continuous state variables;
providing the received continuous state variables to a discretization module configured to:
discretize the received continuous state variables by assigning each received continuous state variable to a cluster, the cluster being one of a plurality of pre-generated clusters, wherein each of the plurality of pre-generated clusters is associated with a cluster center value;
combining, using the anomaly detection module, the discretized continuous state variables and received discrete state variables into discretized state variables and providing the discretized state variables to a rule validation module configured to:
retrieve rule sets associated with all the plurality of components of the CI system, wherein each rule set was generated by applying pattern mining algorithms to sets of discretized baseline state variables, each set being associated with corresponding components of the CI system,
identify discretized state variables that contravene a rule in the retrieved rule set and flag the component of the CI system associated with the identified discretized state variable with an anomaly tag,
provide a first list comprising flagged components of the CI system and their corresponding anomaly tags to a priority list database; and
identifying anomalous components of the CI system based on the first list stored in the priority list database.

12. The method according to claim 11 further comprising the steps of:
providing the received continuous and discrete state variables to a trained anomaly detection model configured to generate predicted state variables for each of the plurality of continuous components of the CI system based on the received continuous and discrete state variables;
for each of the plurality of continuous components of the CI system, computing a cumulative sum (CUSUM) value defining a sum of differences between each predicted state variable and its corresponding received state variable over a predefined time window;
determining whether an anomaly label should be assigned to a continuous component of the CI system by comparing the computed CUSUM value associated with the continuous component to a predetermined anomaly detection threshold, whereby in response to a determination that the CUSUM value associated with the continuous component exceeds the predetermined threshold, associating the corresponding continuous component of the CI system with a corresponding anomaly label;
providing a second list comprising continuous components of the CI system that have been associated with anomaly labels to the priority list database for further evaluation; and
identifying anomalous components of the CI system based on the first and second lists stored in the priority list database.

13. The method according to claim 11, wherein the step of applying pattern mining algorithms to sets of discretized baseline state variables associated with the corresponding components of the CI system to generate each of the rule sets comprises the steps of:
instructing a rules generation module to:
for each set of discretized baseline state variables associated with the corresponding components of the CI system,
apply a Frequent-Pattern growth (FP-growth) algorithm to the set of discretized baseline state variables, the FP-growth algorithm being configured to identify frequent item-sets within the set of discretized baseline state variables, and
apply an Association Rules Mining (ARM) algorithm to the identified frequent item-sets to derive association rules that characterize normal behaviours of the corresponding components of the CI system.

14. The method according to claim 11, wherein each of the plurality of pre-generated clusters is generated by the discretization module being configured to:
receive groups of continuous baseline state variables, wherein each group comprises continuous baseline state variables that are associated with a corresponding component of the CI system;
cluster continuous baseline state variables in each of the groups independently from continuous baseline state variables of other groups, using a K-means clustering algorithm, wherein an optimal number of clusters (k-value) for the K-means clustering algorithm for each of the groups is determined using a Kneedle algorithm; and
classify each of the clusters in each of the groups as pre-generated clusters associated with a corresponding component of the CI system, whereby each of the pre-generated clusters is associated with a cluster center value that defines the centroid of the cluster.

15. The method according to claim 11, wherein the trained anomaly detection model is trained by:
receiving groups of continuous and discrete baseline state variables, wherein each group comprises continuous and discrete baseline state variables that are associated with a corresponding continuous component of the CI system;
extracting and selecting optimized feature sets for the continuous components of the CI system by applying a Genetic algorithm to the groups of continuous and discrete baseline state variables; and
training the anomaly detection model using the selected optimized feature sets, the groups of continuous and discrete baseline state variables and a list of continuous components of the CI system, to generate predicted state variables for a corresponding continuous component at specific timestamps.

16. The method according to claim 15, wherein a fitness function of the Genetic algorithm comprises a linear regression model.

17. The method according to claim 15, wherein the anomaly detection model comprises a Long Short-Term Memory (LSTM) autoencoder model.

18. The method according to claim 11 further comprising the steps of:
continuously monitoring the received continuous state variables to detect data drift, changes to the CI system or performance deviations; and
triggering retraining of the trained anomaly detection model or regenerating of the rule sets associated with each of the plurality of components of the CI system in response to a determination that data drift, changes to the CI system or performance deviations were detected.

19. The method according to claim 18 wherein the triggering of the regenerating of the rule sets further comprises the steps of:
building a docker image of the anomaly detection module; and
instructing the rule validation module to regenerate the rule sets within the docker image by:
obtaining updated sets of discretized baseline state variables, each updated set being associated with a corresponding component of the CI system, wherein for each updated set of discretized baseline state variables,
applying a Frequent-Pattern growth (FP-growth) algorithm to the updated set of discretized baseline state variables, the FP-growth algorithm being configured to identify frequent item-sets within the updated set of discretized baseline state variables, and
applying an Association Rules Mining (ARM) algorithm to the identified frequent item-sets to derive association rules that characterize normal behaviours of the corresponding components of the CI system.

20. The method according to claim 18 wherein the triggering of the retraining of the trained anomaly detection model further comprises the steps of:
building a docker image of the anomaly detection module; and
retraining the anomaly detection model within the docker image by performing the steps of:
receiving updated groups of continuous and discrete baseline state variables, wherein each updated group comprises updated continuous and discrete baseline state variables that are associated with a corresponding continuous component of the CI system;
extracting and selecting optimized feature sets for the components of the CI system by applying a Genetic algorithm to the updated groups of continuous and discrete baseline state variables; and
training the anomaly detection model using the selected optimized feature sets, the updated groups of continuous and discrete baseline state variables and a list of components of the CI system, to generate predicted state variables for a corresponding continuous component at specific timestamps.
